(19) United States
(12) Patent Application Publication
(10) Pub. No.: US 2026/0257591 A1
(43) Pub. Date: Sep. 3, 2026

(54) VEHICLE SEAT WITH TRAVELLING-NUT RECEIVING ELEMENT

(71) Applicant: GRAMMER Aktiengesellschaft, Ursensollen (DE)

(72) Inventor: Konstantin LOREY, Schmidgaden (DE)

(21) Appl. No.: 19/552,088

(22) Filed: Feb. 27, 2026

(30) Foreign Application Priority Data
Mar. 3, 2025 (DE) 102025107944.7

(51) Int. Cl. B60N 2/07

(52) U.S. Cl. CPC B60N 2/0722

(57) ABSTRACT

The invention relates to a vehicle seat (1) comprising a seat assembly (5) with a seat carrier (6) and a seat depth plate (7), the seat depth plate (7) being arranged movably on the seat carrier (6) and being displaceable relative to the seat carrier (6) in a longitudinal direction (X) by a drive unit (9), the drive unit (9) being connected in a force-transmitting manner to a receiving element (13), the receiving element (13) being at least two-part, wherein a first part of receiving element (13a) is fixed to the seat carrier (6) or the seat depth plate (7) and a second part of receiving element (13b) is operatively connected to the drive unit (9) in a tension—and/or compression-transmitting manner and is detachably connected to the first part of receiving element (13a).

### CROSS-REFERENCE TO RELATED APPLICATIONS

This application claims priority to German Patent Application 102025107944.7 filed on Mar. 3, 2025, the contents of which are incorporated by reference herein in their entirety.

### BACKGROUND

The invention relates to a vehicle seat comprising a seat assembly with a seat carrier, a seat depth plate and a drive unit, the seat depth plate being arranged movably on the seat carrier and being displaceable relative to the seat carrier in a longitudinal direction by the drive unit. In addition, the drive unit is connected in a force-transmitting manner to a receiving element.

Utility vehicles such as agricultural machines, construction machines or transport vehicles are typically used continuously over longer periods, so seating comfort for an occupant plays a paramount role. Corresponding vehicle seats are therefore equipped with a variety of comfort features, for example electric adjustment systems.

In existing vehicle seats for utility vehicles, the electric adjustment systems are limited to adjusting the seat height, the distance to a steering wheel or the inclination of the backrest. An electric adjustment of a seat inclination or a seat depth has not previously been provided or can only be implemented with disadvantages. In contrast to passenger cars, where there is ample installation space beneath the vehicle seat for arranging electric drives, the installation space in utility vehicles is severely limited. In particular, vehicle seats in utility vehicles frequently comprise additional spring systems that significantly increase the overall height of the seat. Because of the limited cabin height of utility vehicles, seat components are correspondingly arranged directly on the spring systems or on adjustment rails fastened to the spring systems. To arrange electric adjustment systems, it then becomes necessary to create additional installation space, for example by a thicker seat cushion or by providing an additional distance between the seat carrier and the adjustment rail to accommodate components such as an electric motor.

To implement a vehicle seat for utility vehicles in which comfort is improved by an electric adjustment of the seat depth and optionally the seat inclination, it is provided that a drive unit is arranged between the seat cushion and the seat carrier. However, between the seat cushion and the seat carrier the drive unit or the receiving element is inaccessible in the event of a malfunction, such that the seat assembly would have to be dismantled in a complicated manner.

### SUMMARY

It is therefore an object of the invention to provide a vehicle seat in which the drive unit can be at least partially released from the vehicle seat in the event of a malfunction or for maintenance purposes.

To achieve the object, a vehicle seat is provided comprising a seat assembly with a seat carrier and a seat depth plate, the seat depth plate being arranged movably on the seat carrier and being displaceable relative to the seat carrier in a longitudinal direction by a drive unit, the drive unit being connected in a force-transmitting manner to a receiving element, the receiving element being formed at least in two parts, wherein a first part of receiving element is fixedly connected to the seat carrier or the seat depth plate, and a second part of receiving element is operatively connected to the drive unit in a tension- and/or compression-transmitting manner and is detachably connected to the first part of receiving element.

According to one embodiment, the drive unit is essentially fixed to the second part of receiving element. In one case, the drive unit is fixed to the seat depth plate and the receiving element is fixed to the seat carrier. Alternatively, the seat carrier can be connected to the drive unit and the seat depth plate to the receiving element. According to another embodiment, the vehicle seat includes a seat inclination plate for adjusting a seat inclination, the seat inclination plate being arranged in the vertical direction above the seat depth plate. The drive unit is arranged below the seat inclination plate and above the seat carrier, and in particular also essentially above the seat depth plate. The seat depth plate is preferably connected to the seat carrier by a guide device, the guide device in particular comprising a sliding-block-in-guide-groove guidance, by which the seat depth plate is displaceable relative to the seat carrier in the longitudinal direction. A seat inclination plate is preferably arranged on the seat depth plate such that it is rotatable about a rotation axis extending in a transverse direction. Additionally, the seat inclination plate and the seat depth plate can be arranged so as to partially overlap. Preferably, the drive unit is arranged substantially between the seat inclination plate and the seat depth plate in this overlap region.

In a particularly preferred embodiment, the vehicle seat comprises a seat surface and/or a seat cushion arranged on the seat depth plate, the drive unit being arranged between the seat surface or the seat cushion and the seat carrier.

The seat surface may also be formed by the seat cushion or by the seat depth plate and/or the seat inclination plate.

According to one embodiment, the seat depth plate, the drive unit, preferably the seat inclination plate, and more preferably the seat cushion and/or the seat surface are configured as a seat subassembly that can be inserted jointly into the seat carrier or mounted onto the seat carrier. For this purpose, a sliding-block-in-guide-groove guidance may include guide grooves having insertion openings into which corresponding sliding blocks can be inserted or removed in the vertical direction. The drive unit is preferably fixed to the receiving element during installation or assembly. By means of the drive unit, the seat depth plate or the seat subassembly can then be displaced relative to the seat carrier in the longitudinal direction. In doing so, the sliding blocks preferably move out of the insertion openings, whereby the guide device forms a form-fit between the seat carrier and the seat depth plate in the vertical and transverse directions.

In the event of a malfunction, the seat depth plate or the seat subassembly may not be movable into an assembly position in which the sliding blocks can be removed from the grooves through the insertion openings. Since the drive unit is arranged between the seat carrier and the seat cushion or between the seat depth plate and the seat cushion, the drive unit is generally inaccessible. To nevertheless remove the seat depth plate or the seat subassembly from the seat carrier or to demount it from the seat carrier, the receiving element is made in two parts, with the two parts detachably connected to one another.

In a particularly preferred embodiment, the drive unit comprises a spindle extending essentially in the longitudinal direction and a travelling nut, the spindle and the travelling nut being in thread engagement, and the travelling nut being received in a rotation-secured manner by the receiving element.

In particular, the drive unit also comprises a drive element, for example an electric motor or a manual crank drive. This is preferably connected to the receiving element in a tension—and compression-transmitting manner via a spindle or a rack. In particular, the travelling nut is received in the receiving element in a manner secured against rotation about the longitudinal direction and about the vertical direction.

In a particularly preferred embodiment, the travelling nut has at least one pin extending essentially perpendicular to the longitudinal direction, and the second part of receiving element has at least one partially fork-shaped section, with the pin of the travelling nut being arranged in the fork-shaped section.

Particularly preferably, the pin extends essentially in the transverse direction, with the prongs of the fork-shaped section extending essentially in the vertical direction. In this case, the fork-shaped section partially surrounds the pin. Preferably, the pin can be inserted downward in the vertical direction into the fork-shaped section and into the receiving element. As a result, during assembly of the seat depth plate or the seat subassembly, the travelling nut can be inserted from above into the receiving element.

In a particularly preferred embodiment, the at least one pin is at least partially cylindrical, with the fork-shaped section comprising at least two prongs and an at least partially cuboid or prismatic recess between them in which the at least one pin is arranged.

To facilitate centering between the travelling nut and the receiving element, the pin is preferably partially round. Preferably, the pin is essentially cuboid or prismatic, with two opposite sides, in particular oriented perpendicular to the longitudinal direction, being convexly curved.

In a particularly preferred embodiment, the recess between the two prongs of the fork-shaped section is larger in the longitudinal direction than the pin, and a clamping element is provided which at least partially surrounds the pin and is press-fitted between the pin and the fork-shaped section.

While the curvature assists in inserting the pin into the fork-shaped section, it reduces the contact area between the receiving element and the travelling nut, in particular in the longitudinal direction, thereby increasing the surface pressure. A clamping element is therefore provided between the fork-shaped section and the pin, which substantially complementarily fills an intermediate space between the pin and the fork-shaped section. Additionally, play between the travelling nut and the receiving element may be reduced by the clamping element. The clamping element is preferably elastic and made of a polymer.

According to one embodiment, the travelling nut includes another pin arranged symmetrically with respect to a plane of symmetry defined by the longitudinal and vertical directions. The receiving element is likewise formed symmetrically with a second fork-shaped section. Preferably, the plane of symmetry extends through the rotation axis of the spindle.

In a particularly preferred embodiment, at least the first part of receiving element or the second part of receiving element includes a groove, and at least the second part of receiving element or the first part of receiving element includes a profile complementary to the groove. The first and the second parts of receiving element are connected to each other in a form-fitting manner in the transverse direction and the vertical direction by arranging the profile in the groove.

Preferably, the groove and the profile are substantially T-shaped or cross-shaped and are substantially matched to each other. In particular, the profile is displaceable in the groove in the longitudinal direction. The groove preferably includes a one-sided stop arranged on the side of the receiving element facing away from the drive unit.

In a particularly preferred embodiment, a detachable securing element is provided, the securing element connecting the first part of receiving element and the second part of receiving element to one another in a form-fitting and/or force-fitting manner in the longitudinal direction. Securing elements include, in particular, clamps, buckles, latches or screws.

In a particularly preferred embodiment, the securing element is a threaded pin, the receiving element including a complementary threaded opening, the threaded opening being arranged partially in the first part of receiving element and partially in the second part of receiving element, with a thread engagement between the threaded pin and the threaded opening connecting the first and the second parts of receiving element to one another in a form-fitting and optionally force-fitting manner.

Preferably, the profile and the groove are substantially T- or cross-shaped, with a first web extending essentially in the vertical direction and a second web extending essentially in the transverse direction. The web of the profile extending essentially in the vertical direction includes, at one end, a half threaded opening. The threaded opening extends along the longitudinal direction. Complementarily thereto, the web of the groove extending in the vertical direction includes another half threaded opening. The two threaded-opening halves thus form a complete threaded opening.

In a particularly preferred embodiment, the seat carrier is at least partially shell-shaped, with the receiving element arranged between the seat carrier and the seat cushion or seat surface. The vehicle seat includes an access opening through which the threaded pin and/or a drive recess of the threaded pin can be accessed from outside the vehicle seat.

Preferably, the vehicle seat includes a front, closable access opening through which a tool can be inserted into the seat so that the securing element can be released. In the event of a malfunction of the drive unit, the connection between the first and the second parts of receiving element can thus be released. As a result, the drive unit is separated from the receiving element, and the seat depth plate or the seat subassembly can be moved into an assembly position in which it can be removed from the seat carrier or demounted from the seat carrier.

### DRAWINGS

Further advantageous embodiments are apparent from the dependent claims and the following description in connection with the drawings. In this regard, the drawings show:

FIG. 1 side view of a vehicle seat;

FIG. 2 side view of a seat assembly;

FIG. 3 plan view of a seat assembly with seat inclination plate;

FIG. 4 plan view of a seat assembly without seat inclination plate;

FIG. 5 sectional view of a seat assembly;

FIG. 6 exploded view of a receiving element;

FIG. 7a sectional view of a receiving element;

FIG. 7b frontal sectional view of a receiving element with travelling nut;

FIG. 8 lateral sectional view of a receiving element

### DESCRIPTION

FIG. 1 shows an embodiment of the vehicle seat 1 in a side view. The vehicle seat 1 can be divided along the vertical direction Z into an upper seat assembly 5 and a lower vehicle seat substructure 2. The vehicle seat comprises a lower portion 3, which is mounted to the vehicle body, and an upper portion 4, on which the seat assembly 5 is mounted. The lower portion 3 and the upper portion 4 are height-adjustable and spring-mounted relative to one another by means of a scissor mechanism (not shown). The upper portion 4 additionally comprises a pair of adjustment rails 4a, enabling displacement of the seat assembly 5 relative to the vehicle seat substructure 3 in the longitudinal direction X. The seat assembly 5 comprises a seat carrier 6, in which a seat depth plate 7 and a seat inclination plate 8 connected thereto are inserted. The seat depth plate 7 and the seat inclination plate 8 are configured for joint movement relative to the seat carrier 6 in the longitudinal direction X. A seat cushion 17 is arranged on the seat depth plate 7 and the seat inclination plate 8. The vehicle seat 1 additionally comprises a backrest 18 fastened to the seat carrier 6, as well as a headrest 19 or shoulder support arranged on the backrest 18.

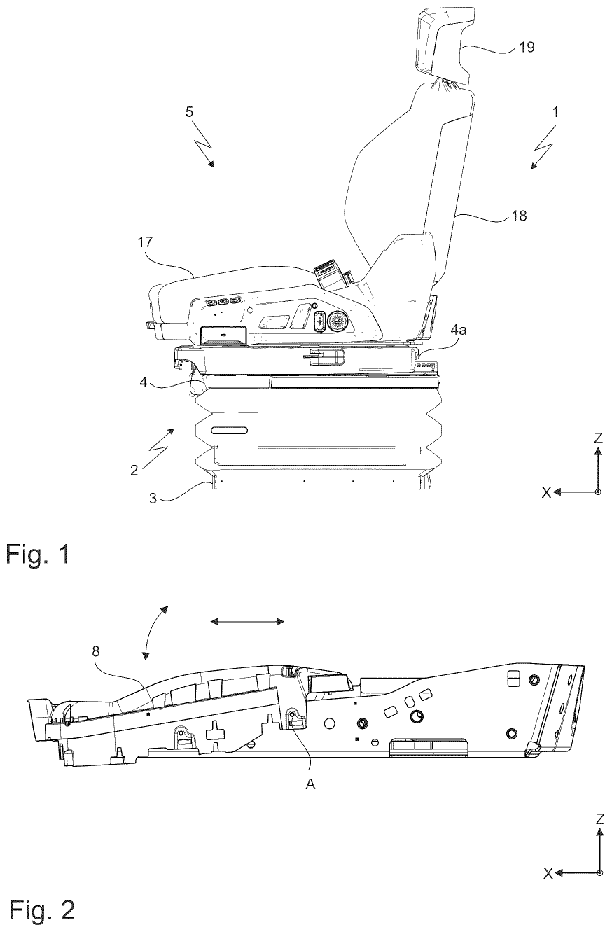

FIG. 2 shows the seat carrier 6 with the seat depth plate 7 and the seat inclination plate 8 in a side view. The seat carrier 6 is of shell-shaped design, with a bottom enclosed by a rear wall, a front wall and two side walls. The seat carrier 6 thus fully encloses the seat depth plate 7 in a shell-shaped manner. The seat depth plate 7 moves within the seat carrier 6.

The seat carrier 6 is likewise closed at the front and has an opening for the seat inclination motor. To adjust a seat inclination, the seat inclination plate 8 is mounted rotatably about the first rotation axis A on the seat depth plate 7. Since the seat depth plate 7 and the seat carrier 6 are arranged substantially parallel to one another, the seat inclination plate 8 is also rotatable relative to the seat carrier 6 about the first rotation axis A. Here, the seat depth plate 7 is essentially shell-shaped, and the seat inclination plate 8 is at least partially shell-shaped to receive a (not shown) seat cushion 17.

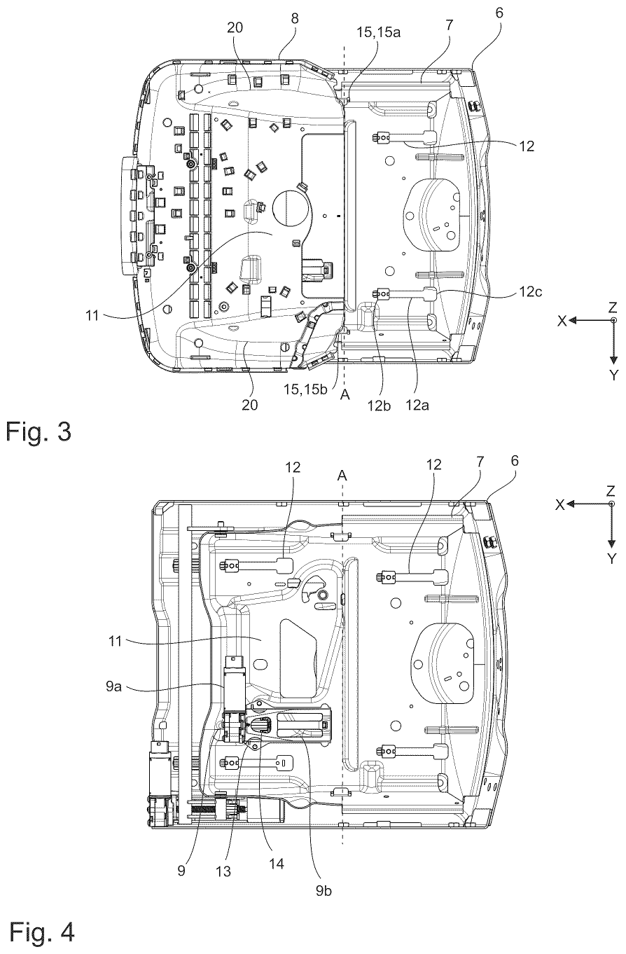

FIG. 3 shows the seat carrier 6, the seat depth plate 7 and the seat inclination plate 8 in a top view. Seen in the vertical direction Z, the seat depth plate 7 is arranged between the seat carrier 6 and the seat inclination plate 8. The seat inclination plate 8 is rotatably connected to the seat depth plate 7 in a rear region via a first floating bearing 15a and a second floating bearing 15b. Furthermore, the seat depth plate 7 is guided by guide devices 12 relative to the seat carrier 6 such that the seat depth plate 7 can essentially only move in the longitudinal direction X. For this purpose, the seat depth plate 7 includes four guide grooves 12a, into which corresponding sliding blocks 12b of the seat carrier 6 are inserted. The guide grooves 12a are arranged in pairs on the right and left in a front section and a rear section of the seat depth plate 7. The sliding blocks 12b can slide within the guide grooves 12a, enabling displacement of the seat depth plate 7 in the longitudinal direction X. The seat depth plate 7 can therefore be moved between an assembly position, in which it is maximally pushed forward relative to the seat carrier and a minimum position, corresponding to minimal seat depth, in which the seat depth plate 7 is maximally pushed rearward. At a rear end, the guide grooves 12a include a removal opening 12c. The removal opening 12c is larger than the sliding blocks 12b, such that the seat depth plate 7 can be removed upward in the vertical direction Z from the seat carrier 6. Conversely, the seat depth plate 7 can also be inserted into the seat carrier 6. In the assembly position, the seat depth plate 7 can be inserted into or removed from the seat carrier 6. Additionally, the seat depth plate 7 and the seat inclination plate 8 have an overlap region 11, in which they overlap. The overlap region 11 extends substantially in the longitudinal direction X from the rotation axis A to a front end of the seat depth plate 7. The seat inclination plate 8 additionally has right- and left-side seat bolsters 20, which support the seat cushion 17 by virtue of the shell-shaped design.

FIG. 4 shows a top view of the seat carrier 6 and the seat depth plate 7. In the overlap region 11, two guide grooves 12a are arranged. Between the two guide grooves 12a, the drive unit 9 is also arranged. The drive unit 9 comprises a first electric motor 9a, which extends substantially in the transverse direction Y and is mounted on the seat depth plate 7. The electric motor 9a drives a first spindle 9b, which extends substantially in the longitudinal direction X. A travelling nut 14 is mounted on the first spindle 9b and is in thread engagement with it. When driven by the first electric motor 9a, rotation of the spindle 9b moves the travelling nut 14 in the longitudinal direction X. For this purpose, the travelling nut 14 is received in a rotation-secured manner in a receiving element 13. The receiving element 13 is fastened to the seat carrier 6, such that rotation of the first spindle 9b moves the seat depth plate 7 relative to the seat carrier 6. Alternatively, the receiving element 13 may be fastened to the seat depth plate 7 and the first drive unit 9 to the seat carrier 6. Additionally, a seat inclination drive unit 10 is arranged partially in front of and partially laterally beside the seat depth plate 7. The seat inclination drive unit 10 is fastened to the seat depth plate 7 and comprises an electric motor, a second spindle, and a second travelling nut. The second electric motor extends essentially in the transverse direction Y, and the second spindle extends essentially in the longitudinal direction X. The second travelling nut is received in a slotted-link guide, which converts the linear movement of the travelling nut into a rotational movement of the seat inclination plate 8 about the rotation axis A.

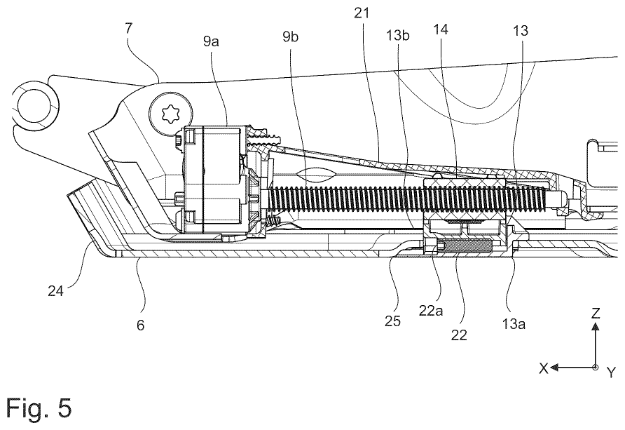

FIG. 5 shows a section through a seat assembly 5 with the seat depth plate 7 and the seat carrier 6. Both the seat depth plate 7 and the seat carrier 6 are shell-shaped, with the seat carrier 6 receiving the seat shell. The first electric motor 9a is arranged in a front region of the seat depth plate 7 near a flange of the seat depth plate 7 and is fixed thereto.

Adjacent to and operatively connected with the electric motor 9a is the spindle 9b, which extends substantially in the longitudinal direction X. The electric motor 9a and particularly the spindle 9b are received by a retaining element 21, which supports the spindle 9b at least in a rear end region. The front end region of the spindle 9b is received by the electric motor 9a.

The spindle 9b also passes through the receiving element 13, in which a travelling nut 14 (not shown here) is received in a rotation-secured manner. The receiving element 13 consists of a first part 13a, which is fixed to the seat carrier 6, and a second part 13b, which is detachably connected to the first part. To connect the first part 13a and the second part 13b, a threaded pin 22 is provided, which includes a drive recess 22a in the form of an internal hexagon. The receiving element 13 includes a threaded opening 23 for the threaded pin 22, the threaded opening 23 extending partly in the first part 13a and partly in the second part 13b. To access the drive recess 22a of the threaded pin 22, the seat carrier 6 includes an access opening 24, arranged at the front side of the seat carrier 6, through which a tool can be inserted between the seat carrier 6 and the seat depth plate 7 to loosen the threaded pin 22. In front of the receiving element 13, a release opening 25 is provided in the bottom of the seat carrier 6, through which the threaded pin 22 can be discharged from the seat carrier 6.

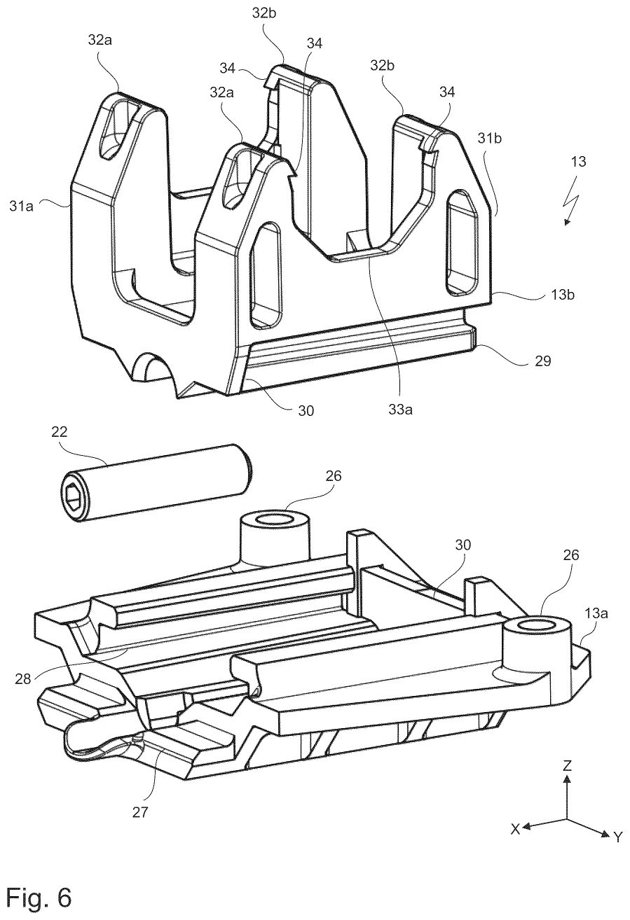

FIG. 6 shows an exploded view of the receiving element 13. The first part 13a includes two bushings 26, by which the first part 13a can be screwed to the seat carrier 6. On its front side, the first part 13a includes a spigot 27, by which the first part 13a engages spigot-like with the seat carrier 6 and can be screwed thereto via the bushings 26. The first part 13a further includes a groove 28, into which a profile 29 of the second part 13b can be inserted. The first part 13a includes a rear stop 30, and the second part 13b includes a front stop 30, which partially limit the movement of the profile 29 in the groove 28 in the longitudinal direction X. The second part 13b is designed to absorb tension and compression forces.

It comprises a first fork section 31a and a second fork section 31b, each with a front prong 32a and a rear prong 32b. The front prongs 32a and the rear prongs 32b enclose a trapezoidal recess 33a for receiving the travelling nut 14. At their upper ends, the prongs 32a, 32b include hooks 34, by which clamping elements 36 (not shown) can be fixed in the trapezoidal recesses 33a. Between the fork sections 31a and 31b, the spindle 9b extends, and is fork-embraced particularly by the second part 13b. In this depiction, the second part 13b is arranged above the first part 13a, with both parts 13a and 13b enclosing the threaded pin 22.

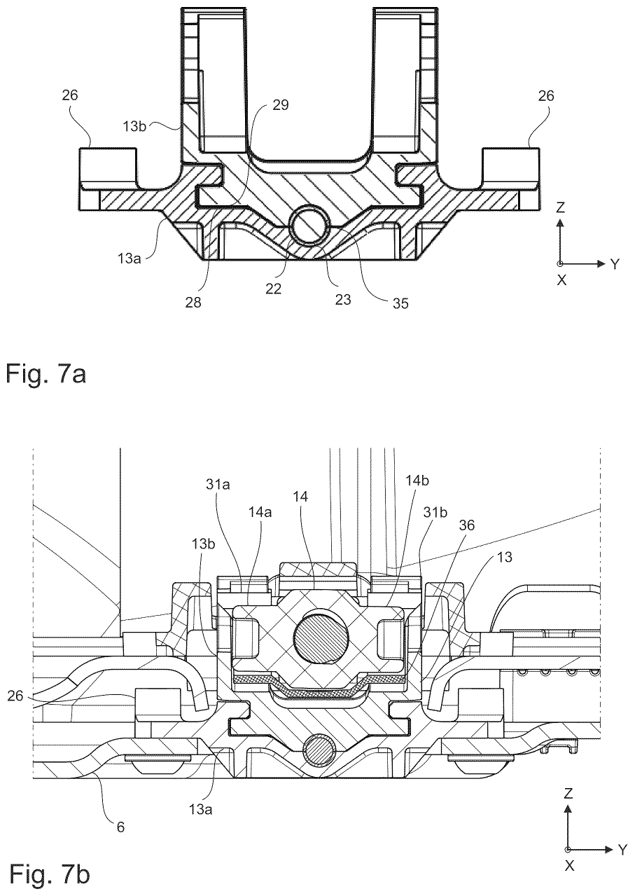

FIG. 7a shows a section through the receiving element 13. In the lower region, the first part 13a is arranged, with the bushings 26 extending wing-like to the right and left. Above this, the second part 13b is arranged, the two parts engaging one another. The first part 13a includes an essentially T-shaped groove 28, and the second part 13b includes a complementary T-shaped profile 29. The groove 28 and profile 29 have a central thickened region 35, in which the threaded opening 23 or the threaded pin 22 is received. The thread engagement between the threaded pin 22 and the threaded opening 23 forms a form-fitting force transmission between the first part 13a and the second part 13b, connecting them firmly but detachably.

FIG. 7b shows a sectional detail of the seat carrier 6 and the receiving element 13. In the second part 13b, the travelling nut 14 is arranged between the first fork section 31a and the second fork section 31b. The travelling nut 14 includes a first pin 14a and a second pin 14b, which are received in the trapezoidal recesses 33a. Both pins 14a, 14b extend substantially in the transverse direction Y. Between the travelling nut 14 and the receiving element 13, an elastic clamping element 36 is arranged, which reduces or eliminates play between the receiving element 13 and the travelling nut 14. The spindle 9b passes centrally through the travelling nut 14 and is in thread engagement with it.

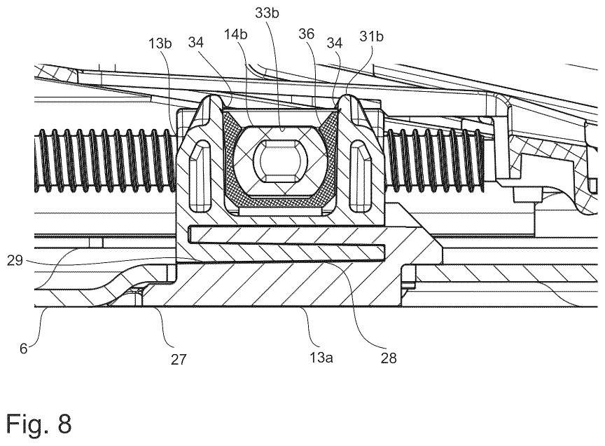

FIG. 8 shows a section through the receiving element 13 and the travelling nut 14 in a further embodiment. The receiving element 13 is spigot-mounted to the seat carrier 6, with the spigot 27 arranged beneath the seat carrier 6. The groove 28 and the profile 29 are wedge-shaped in the longitudinal direction X, with a front portion higher in the vertical direction Z than a rear portion. The second fork section 31b encloses a rectangular recess 33b, in which the second pin 14b is received. The second pin 14b is surrounded in a fork-like manner by the clamping element 36, which is fixed in the recess 33b by the hooks 34.

The clamping element 36 is open at the top, allowing the pin 14b to be inserted downward into the fork section 31b or into the clamping element 36. The second pin 14b of the travelling nut 14 is at least partially cuboid, and its sides facing the prongs 32a, 32b are convexly curved.

### LIST OF REFERENCE SIGNS

1 vehicle seat
2 vehicle seat substructure
3 lower portion
4 upper portion
4a adjustment rails
5 seat assembly
6 seat carrier
7 seat depth plate
8 seat inclination plate
9 drive unit
9a first electric motor
9b first spindle
10 seat inclination drive unit
11 overlap region
12 guide device
12a guide groove
12b sliding blocks
12c removal opening
13 receiving element
13a first part
13b second part
14 travelling nut
14a first pin
14b second pin
15 floating bearing
15a first floating bearing
15b second floating bearing
16 seat subassembly
17 seat cushion
18 backrest
19 headrest
20 seat bolster
21 retaining element
22 threaded pin
22a drive recess
23 threaded opening
24 access opening
25 release opening
26 bushing
27 spigot
28 groove
29 profile
30 stop
31a first fork section
31b second fork section
32a front prong
32b rear prong
33a trapezoidal recess
33b rectangular recess
34 hooks
35 thickened region
36 clamping element
A rotation axis
X longitudinal direction
Y transverse direction
Z vertical direction

1. A vehicle seat (1), comprising a seat assembly (5) with a seat carrier (6) and a seat depth plate (7), wherein the seat depth plate (7) is arranged movably on the seat carrier (6) and is displaceable relative to the seat carrier (6) in a longitudinal direction (X) by a drive unit (9), wherein the drive unit (9) is connected in a force-transmitting manner to a receiving element (13), characterised in that the receiving element (13) is at least two parts, wherein a first part of the receiving element (13a) is fixed to the seat carrier (6) or the seat depth plate (7) and a second part of the receiving element (13b) is operatively connected to the drive unit (9) in a tension-and/or compression-transmitting manner and is detachably connected to the first part of the receiving element (13a).

2. The vehicle seat (1) according to claim 1, characterised in that the vehicle seat (1) comprises a seat surface and/or a seat cushion (17) arranged on the seat depth plate (7), the drive unit (9) being arranged between the seat surface and/or seat cushion (17) and the seat carrier (6).

3. The vehicle seat (1) according to any one of the preceding claims, characterised in that the drive unit (9) comprises a spindle (9b) extending essentially in the longitudinal direction (X) and a travelling nut (14), the spindle (9b) and the travelling nut (14) being in thread engagement and the travelling nut (14) being received so as to be secured against rotation by the receiving element (13).

4. The vehicle seat (1) according to claim 3, characterised in that the travelling nut (14) has at least one pin (14a, 14b) extending essentially perpendicular to the longitudinal direction (X), and the second part of the receiving element (13b) has at least one at least partially fork-shaped section (31a, 31b), the pin (14a, 14b) of the travelling nut (14) being arranged in the fork-shaped section (31a, 31b).

5. The vehicle seat (1) according to claim 4, characterised in that the at least one pin (14a, 14b) is at least partially cylindrical, the fork-shaped section (31a, 31b) comprising at least two prongs (32a, 32b) and an at least partially cuboid or prismatic recess (33b) between them in which the at least one pin (14a, 14b) is arranged.

6. The vehicle seat (1) according to claim 3 or 4, characterised in that the recess between two prongs (32a, 32b) of the fork-shaped section (31a, 31b) is larger than the pin (14a, 14b) in the longitudinal direction (X), a clamping element (36) being provided which at least partially surrounds the pin (14a, 14b) and is press-fitted between the pin (14a, 14b) and the fork-shaped section (31a, 31b).

7. The vehicle seat (1) according to any one of the preceding claims, characterised in that at least the first part of the receiving element (13a) or the second part of the receiving element (13b) has a groove (28) and at least the second part of the receiving element (13b) or the first part of the receiving element (13a) has a profile (29) complementary to the groove (28), the first part of the receiving element (13a) and the second part of the receiving element (13b) being connected to one another in a form-fitting manner in a transverse direction (Y) and a vertical direction (Z) by arranging the profile (29) in the groove (28).

8. The vehicle seat (1) according to claim 7, characterised in that a detachable securing element (22) is provided, the securing element (22) connecting the first part of the receiving element (13a) and the second part of receiving element (13b) to one another in a form-fitting and/or force-fitting manner in the longitudinal direction (X).

9. The vehicle seat (1) according to claim 8, characterised in that the securing element (22) is a threaded pin (22), the receiving element (13) having a complementary threaded opening (23), the threaded opening (23) being arranged partially in the first part of the receiving element (13a) and partially in the second part of the receiving element (13b), a thread engagement between the threaded pin (22) and the threaded opening (23) connecting the first part of the receiving element (13a) and the second part of the receiving element (13b) to one another in a form-fitting and optionally force-fitting manner.

10. The vehicle seat (1) according to claim 9, characterised in that the seat carrier (6) is at least partially shell-shaped, the receiving element (13) being arranged between seat carrier (6) and seat cushion (17) and/or seat surface, and the vehicle seat (1) having an access opening (24), wherein the threaded pin (22) and/or a drive recess (22a) of the threaded pin being accessible from outside the vehicle seat (1) through the access opening (24).
